(19) United States
(12) Patent Application Publication
(10) Pub. No.: US 2011/0255654 A1
(43) Pub. Date: Oct. 20, 2011

(54) System and method processing images in multi-energy X-ray system

(75) Inventors: Sung Su Kim, Yongin-si (KR); Seok Min Han, Seongnam-si (KR); Young Hun Sung, Hwaseong-si (KR); Jong Ha Lee, Hwaseong-si (KR); Dong Goo Kang, Suwon-si (KR); Kwang Eun Jang, Busan (KR)

(73) Assignee: SAMSUNG ELECTRONICS CO., LTD., Suwon-si (KR)

(21) Appl. No.: 13/064,656

(22) Filed: Apr. 6, 2011

(30) Foreign Application Priority Data
Apr. 6, 2010 (KR) 10-2010-0031294

(51) Int. Cl. G01N 23/087; G06K 9/00

(52) U.S. Cl. 378/5; 382/132

(57) ABSTRACT

An image processing system and method are provided to adaptively discriminate hard tissues and soft tissues of a target in a multi-energy X-ray system. The image processing system and method may minimize a decrease in a dynamic range (DR) for soft tissues affected by hard tissues in a target where the soft tissues and hard tissues are mixed.

### CROSS-REFERENCE TO RELATED APPLICATIONS

This application claims the benefit of Korean Patent Application No. 10-2010-0031294, filed on Apr. 6, 2010, in the Korean Intellectual Property Office, the disclosure of which is incorporated herein by reference.

### BACKGROUND

1. Field

One or more embodiments of the following description relate to a system and method for processing images in a multi-energy X-ray system, and more particularly, to a system and method for processing images by adaptively discriminating hard tissues and soft tissues of a target using target images of a target generated by an X-ray with plural energy bands.

2. Description of the Related Art

A large number of X-ray systems may display images using attenuation characteristics that are detected by passing an X-ray having a single energy band through a target. In such X-ray systems, when materials forming the target have different attenuation characteristics, such as the differing attenuation characteristics between soft and hard tissues, high quality images may be acquired. Conversely, when the materials have similar attenuation characteristics, such as between two distinct neighboring soft tissues, an image quality may be degraded.

A multi-energy X-ray system may acquire an X-ray image from an X-ray having at least two energy bands. In general, since differing materials are respectively seen as having different X-ray attenuation characteristics in different energy bands, a separation of images for each material may be performed using the X-ray attenuation characteristics.

Currently, the Computed Tomography (CT) scanner or a nondestructive inspector having a dual energy source or a dual energy separation detector has emerged. In these devices, a density image for materials forming a target may be acquired by rotating a source by at least 180° relative to the target. In such a dual-energy CT device, an image having a regular quality may be acquired using a relatively simple scheme of adding, subtracting, or segmenting acquired images and masking pseudo-colors. Similar to the multi-energy X-ray system, where the X-ray attenuation characteristics are used, the dual-energy CT device uses density characteristics for differing materials. Depending on how densities of neighboring tissues within the target affect the detection of the different densities, density measurements may include errors.

A target may be broadly divided into hard tissues and soft tissues. Hard tissues are solid, and include, for example, bones. When a hard tissue overlaps another tissue located below or above the hard tissue, e.g., from the perspective of the energy source and X-ray detector, the image quality may be degraded. Additionally, since even a hard tissue such as a bone has irregular attenuation characteristics, it is difficult to completely solve such an overlapping problem. In addition, the dynamic range (DR) for soft tissues is caused to decrease when a target area includes a mix of hard and soft tissues, and the proximity between hard and soft tissues may impede accurate measurements. Additionally, with one or more of these approaches, the spectrum of the X-ray source used to generate the image and/or a mass attenuation curve of the target are typically needed.

### SUMMARY

Accordingly, in one or more embodiments there is provided a system and method of adaptively discriminating hard tissues and soft tissues without, or without the need for, some or all information regarding spectrum characteristics of an X-ray source and a mass attenuation curve of a target. Accordingly, in one or more embodiments, tissue discrimination may be performed based on information of images only, by implementing an adaptive discrimination method, as described in greater detail below. One or more embodiments further include selectively enhancing contrast levels for soft tissue images, even when soft and hard tissues overlap, in the applying of the adaptive discrimination method.

The foregoing and/or other aspects are achieved by providing multi-energy X-ray system, the system including an image matching unit to match a plurality of target images representing plural energy bands of at least one X-ray, detected after passing through a target, by separating the plurality of target images into images for respective energy bands to generate at least one matched target image, and a tissue discriminating unit to detect a specific region within the matched target image, to determine a difference image coefficient to separate images including the specific region into a plurality of tissue images, and to discriminate the plurality of tissue images from the matched target image using the difference image coefficient to generate at least one tissue image of the matched target image.

The foregoing and/or other aspects are achieved by providing method, the method including matching a plurality of target images representing plural energy bands of at least one X-ray, detected after passing through a target, by separating the plurality of target images into images for respective energy bands to generate at least one matched target image, detecting a specific region within the matched target image, determining a difference image coefficient to separate images including the specific region into a plurality of tissue images, and discriminating the plurality of tissue images from the matched target image using the difference image coefficient, the discriminating of the plurality of tissues images for generating at least one tissue image of the matched target image.

Additional aspects, features, and/or advantages of embodiments will be set forth in part in the description which follows and, in part, will be apparent from the description, or may be learned by practice of one or more embodiments of the disclosure.

### BRIEF DESCRIPTION OF THE DRAWINGS

These and/or other aspects and advantages will become apparent and more readily appreciated from the following description of embodiments, taken in conjunction with the accompanying drawings of which:

FIG. 1 illustrates a multi-energy X-ray image processing system, according to one or more embodiments;

FIG. 2 illustrates an image processing/analyzing unit, such as of the multi-energy X-ray image processing system of FIG. 1, according to one or more embodiments;

FIG. 3 illustrates a tissue discriminating unit, such as of the image processing/analyzing unit of FIG. 2, according to one or more embodiments;

FIG. 4 illustrates a specific region detector of a tissue discriminating unit, such as the tissue discriminating unit of FIG. 3, according to one or more embodiments; and

FIG. 5 illustrates a method of processing images through multi-energy X-ray image processing, according to one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

A multi-energy X-ray image processing system, according to one or more embodiments, may denote a system using at least an X-ray source generating an X-ray having at least two energy bands, two X-ray sources generating respective X-rays with different energy bands, and/or using an X-ray detector configured to have the capability to perform a separation of images for each of two energy bands or more. The multi-energy X-ray image processing system may be implemented by any one of a radiography system, a tomosynthesis system, a Computed Tomography (CT) system, and a nondestructive inspector, for example, that are also configured to have the capability to perform a separation of image for each of the two energy bands or more, noting that these discussed systems are merely examples, and additional and/or alternate systems are equally available. Accordingly, in view of the below disclosure, it should be well understood by those skilled in the art that a multi-energy X-ray image processing system and method may be implemented by various device types and ways, according to differing embodiments.

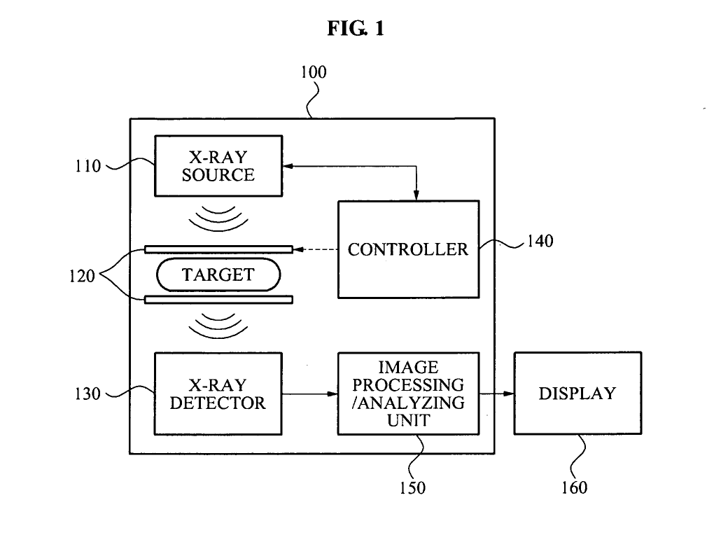

FIG. 1 illustrates a multi-energy X-ray image processing system 100, according to one or more embodiments.

Referring to FIG. 1, as only an example, the multi-energy X-ray image processing system 100 may include an X-ray source 110, an X-ray detector 130, a controller 140, and an image processing/analyzing unit 150. The multi-energy X-ray image processing system 100 may further include a stage 120 depending on implementation of the image processing system 100. In differing embodiments, the display 160 is included in or separate from the image processing system 100. In addition, in one or more embodiment, any of the controller 140, X-ray detector 130, image processing/analyzing unit 150, or display 160 may include a memory. For example, the image processing/analyzing unit 150 may store generated optimal images, soft-tissue images, or hard-tissue images to the memory of the image processing/analyzing unit 150 or to a memory remote from the image processing/analyzing unit 150. In one or more embodiments, the image processing/analyzing unit 150 is further configured to control the display of any detected target images, optimal images, or hard and soft tissue images by display 160, noting that embodiments further include storing and displaying of alternative or additional images available at any of the below described units or operations.

The X-ray source 110 may radiate X-rays toward a target illustrated in FIG. 1, such that the X-rays radiate through the target toward the X-ray detector 130. The X-rays radiated from the X-ray source 110 may include photons having a plurality of energy levels, e.g., a plurality of distinct predetermined energy levels. The X-rays passing through the target may be detected by the X-ray detector 130. A dose and voltage of the X-rays radiated from the X-ray source 110, and a radiation time may be controlled by the control unit 140 which will be described in greater detail below.

The stage 120 may be a device used to fix the target. Depending on embodiments, the stage 120 may be designed to selectively immobilize the target by applying a predetermined amount of pressure to the target or by removing the applied pressure from the target.

The X-ray detector 130 may acquire a plurality of target images that are formed by passing multi-energy X-rays, from the X-ray source 110, through the target. Specifically, the X-ray detector 130 may detect X-ray photons from the X-ray source 110 after passing through the target for each of plural energy bands, thereby acquiring the plurality of target images. As only an example, in one or more embodiments, X-ray detector 130 may be a photo counting detector (PCD), which may discriminate between energy.

The controller 140 may control the X-ray source 110 so that an X-ray may be radiated to the target in a predetermined dose/voltage within or during a predetermined time period. Additionally, at any time during the process, the controller 140 may control the stage 120 to adjust the pressure applied to the target.

The image processing/analyzing unit 150 may perform image processing on the target images acquired by the X-ray detector 130 during the predetermined time interval. An image processing scheme according to one or more embodiments will be described in greater detail below.

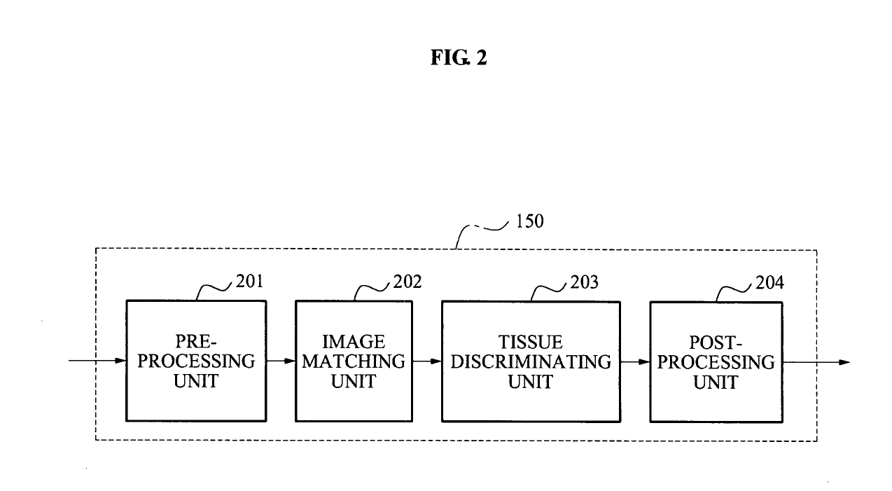

FIG. 2 illustrates an image processing/analyzing unit, such as the image processing/analyzing unit 150 of FIG. 1, according to one or more embodiments.

In one or more embodiments, the image processing/analyzing unit 150 includes an image matching unit 202 and a tissue discriminating unit 203. The image processing/analyzing unit 150 may further include a pre-processing unit 201 and a post-processing unit 204, for example.

(1) Pre-Processing for Target Image

The pre-processing unit 201 may be configured to perform a pre-processing on the target images, i.e., at least images generated by the X-ray detector 130 from the radiating of the X-rays through the target. In one or more embodiment, the pre-processing unit 201 considers target images including a desired examination Region of Interest (ROI) of the target differently from target images that do not include the ROI. In an embodiment, the ROI may be predetermined, e.g., by a user, before X-rays are radiated to the target and target images generated. In one or more embodiments, the surrounding target images not including the detected ROI are separately stored, e.g., in a memory of the image processing/analyzing unit 150, so that the stored target images corresponding to the ROI may be selectively referred to for when an image is displayed. Herein, embodiments may further include displaying and/or printing of stored images. Another example of the pre-processing would be a removal, from a target image, of one or more motion artifacts generated due to a movement of the target, for example.

(2) Matching of Target Image

The image matching unit 202 may receive respective projection images (E1 through EN) of energy bands generated by the multi-energy-X-ray spectrum passing through differing materials making up the target, and may estimate an initial image for each of M materials that may be constituting the target. In one or more embodiments, in the matching of the target images, the image matching unit 202 may divide or separate the plurality of target images into images for each energy level, and may then apply a weighted sum scheme to the images, to determine which target images to match.

(3) Tissue Discrimination for Target Image

In one or more embodiments, the tissue discriminating unit 203 may discriminate hard tissues from soft tissues by applying the following adaptive discrimination method to one or more of the matched target images.

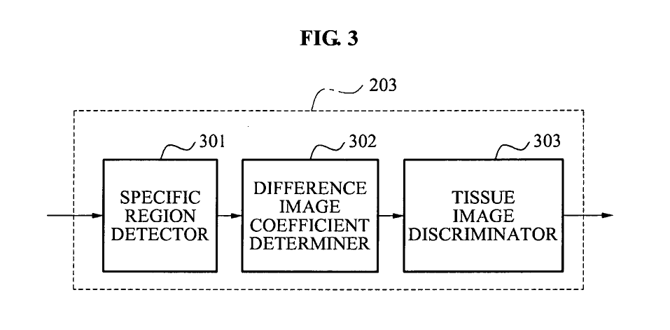

FIG. 3 illustrates a block diagram of a tissue discriminating unit, such as the tissue discrimination unit 203 of the image processing/analyzing unit 150, according to one or more embodiments.

Referring to FIG. 3, as only an example, the tissue discriminating unit 203 may include a specific region detector 301, a difference image coefficient determiner 302, and a tissue image discriminator 303.

The specific region detector 301 may detect a specific region within the matched target image. Herein, a specific region refers to a region that may be optimal for tissue discrimination. The specific region may be detected by comparing a feature model image stored in a feature model storage unit with a result value obtained by performing a pattern analysis. The pattern analysis may include an edge extraction algorithm and a frequency domain analysis with respect to the matched target image. In one or more embodiments, for example, the pattern analysis may include finding a region within the matched target image that has a predetermined level of similarity to stored models, and/or a region within the matched target image relative to a body or volume within the target image identified by the pattern analysis.

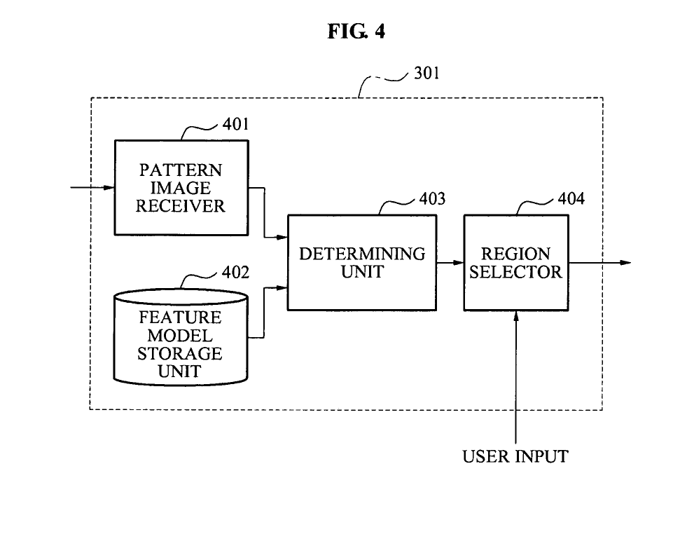

FIG. 4 illustrates a specific region detector, such as the specific region detector 301 of FIG. 3, according to one or more embodiments. Referring to FIG. 4, as only an example, the specific region detector 301 may include a pattern image receiver 401, a feature model storage unit 402, a determining unit 403, and a region selector 404.

To detect the specific region of the matched target image, the pattern image receiver 401 may select candidate images within the ROI. Here, the ROI may be a local region related to a part of the target, or a global region. In one or more embodiments, pre-processing unit 201 or tissue discriminating unit 203, as only examples, include a user interface and detect a ROI selected by the user and/or may automatically determine the ROI to be one of predetermined local regions or the global region, e.g., if the image processing system 100 does not include the user interface or no input is detected. In another embodiment, the user interface is included in an alternate unit of the image processing system 100, including the display 160, or separate from the image processing system 100 with display 160.

The feature model storage unit 402 may store user settings and/or one or more feature model images obtained while an image processing system operates, according to one or more embodiments. In one or more embodiments, the feature model images include feature model images stored before the target images are generated, and may further be feature model images generated through an image processing system that was not performing the adaptive discrimination method of one or more embodiments.

The determining unit 403 may compare the candidate images selected by the pattern image receiver 401 with the feature model image stored in the feature model storage unit 402, and may select a candidate image having a high correlation with the feature model image among the candidate images, so that the specific region may be detected by the region selector 404. In an embodiment, the region selector 404 may receive a user input, e.g., through the above discussed user interface, and may determine the specific region in response to the user input. The user input may be an input regarding how to view an image representing the selected ROI. User inputs regarding a display of an image based on tissues or other elements as references may be received, and an output of the region selector 404 may be controlled in response to the user inputs. In one or more embodiments, the user input may further include an identification of at least one material, e.g., which may be expected within the target, to be represented in a local or global region of the target image.

An image output from the region selector 404 may be an image obtained by further correlating a pattern image with a feature model image. In one or more embodiments, one or more of these correlations may be performed by analyzing frequencies of the image, and applying the result of that analysis to neural machine, such as a super vector machine (SVM) or a Multilayer Perceptron (MLP) with feature modeling from a learned model, for example.

Referring back to FIG. 3, the difference image coefficient determiner 302 may determine a difference image coefficient. The difference image coefficient refers to an optimal coefficient used to divide, or separate, a plurality of images representing the specific region detected by the specific region detector 301 into tissue images. A difference image may refer to an image representing a difference between images for each energy band. Additionally, the difference image coefficient may be determined as a value for minimizing a predetermined cost function. The cost function may be associated with frequency characteristics of the tissue images. As only example, a change in the frequency domain in an image may be analyzed, and the difference image coefficient can be extracted where the maximum discrimination level is achieved, using a subtraction scheme or mono or multi-dimensional polynomials applied to multiple images acquired from the region having the different energy bands. According to another embodiment, the cost function may be associated with entropy characteristics of the tissue images.

The difference image coefficient determiner 302 may generate a ROI difference image for the ROI, may analyze a cost function related to the ROI difference image, and may determine a difference image coefficient to minimize the analyzed cost function. In an embodiment, in a cost function using frequency characteristics, a difference image coefficient may be determined based on a change in a high frequency characteristic function, a change in a low frequency characteristic function, and a change in an entire frequency characteristic function. For example, when the cost function is defined as a frequency characteristic function, a first image among images for each energy band may be subtracted from a value obtained by multiplying a second image by an unknown difference image coefficient. In this example, a difference image coefficient for minimizing the cost function may be determined based on a maximum value of multiple Discrete Cosine Transform (DCT) coefficients. The difference image coefficient, as the optimal coefficient for the ROI, may be selected from among the multiple coefficients. If the ROI is a local region related to only a portion of the radiated target, then the optimal coefficient is a local region coefficient, while if the ROI is a global region related to all or a majority of the radiated target, then the optimal coefficient is a global region coefficient. One or more embodiments include generating a global region coefficient from multiple local region coefficients, or generating an image by applying a local region coefficient and the global image coefficient of the multiple local region coefficients. Accordingly, in one or more embodiment, a global image may be generated by combining the global region with at least one local region by using one or more of the respective global region coefficient and respective at least one local region coefficient.

The tissue image discriminator 303 may discriminate the tissue images based on the difference image coefficient determined by the difference image coefficient determiner 302. Specifically, the tissue image discriminator 303 may optimize the target image based on the difference image coefficient determined by the difference image coefficient determiner 302, and may generate hard tissue images and soft tissue images based on the optimized target image. Additionally, to optimize the target image, the difference image coefficient may be adjusted in response to a user input.

The tissue image discriminator 303 may synthesize the generated hard tissue images and generated soft tissue images, to generate an optimal image. In an embodiment, to obtain the optimal image, a color coding or a color fusion may be performed, or hard tissue images or soft tissue images may be individually output in response to a user input when a user desires to view hard tissue images or soft tissue images.

In one or more embodiments, the above adaptive discrimination method, and system configured to perform the adaptive discrimination method, is enabled to discriminate between hard tissues and soft tissues based on information of the captured images, and does not use information regarding spectrum characteristics of an X-ray source or a mass attenuation curve of the target to discriminate between the hard and soft tissues. The adaptive discrimination method may discriminate between the hard and soft tissues using only the captured images.

(5) Post-Processing for Image

A post-processing may be performed on the optimal image, for example, derived from the target image processed through the above-described image processing schemes (2) to (4). The post-processing may employ, for example, a scheme of generating a de-blur mask based on an X-ray scattering modeling with respect to the optimal image generated by the tissue image discriminator 303, and of controlling a contrast level of a soft tissue image using the de-blur mask. For example, accordingly, the adaptive discrimination method generating the optimal image may include selectively enhancing the contrast level of the soft tissue image, even when soft and hard tissues overlap.

The multi-energy X-ray image processing system 100 may perform the image processing in various combinations of the above-described image processing schemes (1) to (5). For example, according to an embodiment, the pre-processing scheme (1) and the post-processing scheme (5) may be selectively adopted.

Accordingly, in or more embodiments, the image processing system 100 implements the adaptive discrimination method, e.g., through an image matching unit that divides or separates a plurality of images for plural energy levels into matched images for each energy level and a tissue discriminating unit that discriminates tissues from within the matched images, such as the image matching unit 202 and tissue discrimination unit 203 of FIG. 2, or merely through the image processing/analyzing unit 150, and may further include the generating of the X-ray energy, radiation of X-rays through the target, subsequent detection, and display and/or storage of the tissue discrimination results of the image processing system.

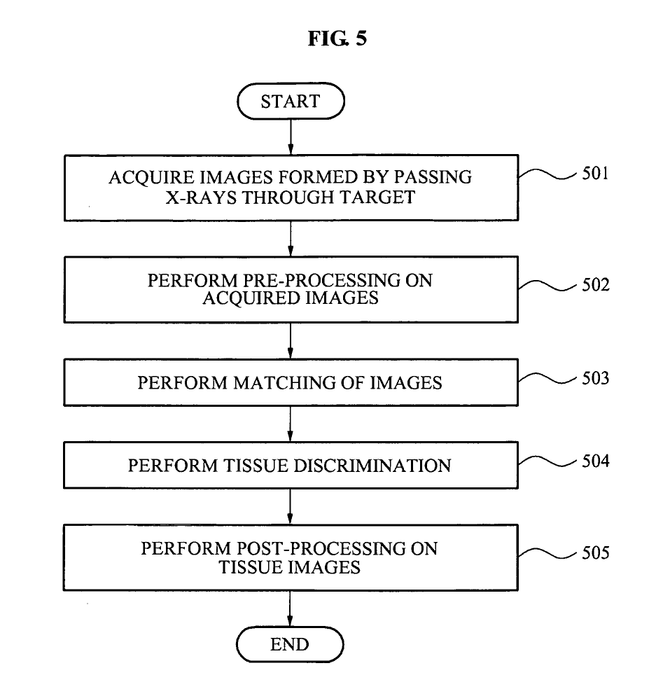

FIG. 5 illustrates a method of processing images, such as in a multi-energy X-ray image processing system, according to one or more embodiments. In addition to the description below, embodiments of the method of processing images may include operations described above with regard to configuration and capability of the image processing system 100, and respective varying embodiments of the image processing system 100 as set forth in any of FIGS. 1-4.

Referring to FIG. 5, in operation 501 a plurality of images may be acquired by detecting a multi-energy X-ray that has passed through a target. In operation 501, an X-ray with photons of plural energy bands may be detected from an X-ray source, for each energy band, and a plurality of target images may be generated based upon the detected X-ray representing the passing of the X-ray through the target. In an embodiment, operation 501 further includes radiating the X-ray photons with the plural energy bands from the X-ray source toward the target.

In operation 502, a pre-processing may be performed on the generated images. As an example of the pre-processing, a Region of Interest (ROI) desired to be examined from the target may be predetermined, and surrounding target images of the detected ROI may be separately stored from target images including the ROI, so that the stored target images may be distinctly referred to when an image is displayed. Another example of the pre-processing is the removal, from a target image, of motion artifacts, such as motion artifacts generated due to a movement of the target during the radiation of the X-ray photons.

In operation 503, the target images may be matched. In one or more embodiments, in operation 503, the plurality of target images may be divided or separated into images for each energy level, and the target images that should be matched may be determined by applying a weighted sum scheme to the images.

In operation 504, a specific region of the matched target image may be detected, a difference image coefficient may be determined, and tissue images may be discriminated using the difference image coefficient. Specifically, the specific region of the matched target image obtained in operation 503 may be detected. Herein, a specific region refers to a region optimized for tissue discrimination. The specific region may be detected by comparing a feature model image stored in a feature model storage unit with a result value obtained by performing a pattern analysis. The pattern analysis may include an edge extraction algorithm and a frequency domain analysis with respect to the matched target image, as only examples. Additionally, the specific region may be detected in response to the user input, and at least one of operations 501-504 may include requesting and/or detecting the user input. The user input may be an input regarding how to view an image representing the selected ROI. User inputs regarding a display of an image based on tissues or other elements as references may be received. The difference image coefficient may be determined. Here, the difference image coefficient refers to an optimal coefficient used to divide a plurality of images representing the detected specific region into tissue images. A difference image may refer to an image representing a difference between images for each energy band. Additionally, the difference image coefficient may be determined as a value for minimizing a predetermined cost function. The cost function may be associated with frequency characteristics of the tissue images, as only an example. According to another embodiment, the cost function may be associated with entropy characteristics of the tissue images.

In operation 504, the tissue images may be discriminated based on the difference image coefficient. Specifically, the target image may be determined to be optimal based on the determined difference image coefficient, and hard tissue images and soft tissue images may be generated based on the optimized target image. Additionally, in an embodiment, to optimize the target image, the difference image coefficient may be adjusted in response to a user input, with at least operation 504 including the request and/or detection of the user input.

In operation 504, the generated hard tissue images and the generated soft tissue images may be synthesized, so that an optimal image may be generated.

In operation 505, a post-processing may be performed on the discriminated tissue images. The post-processing may employ, for example, a scheme of generating a de-blur mask based on an X-ray scattering modeling with respect to the optimal image generated by the tissue image discriminator 303 in operation 504, and of controlling a contrast level of a soft tissue image using the de-blur mask.

In the method described above with reference to FIG. 5, the pre-processing, namely operation 502, and the post-processing, namely operation 505, may be selectively adopted. Additionally, in an embodiment, any of operations 504 or 505, as only an example, may include a storing of such optimal, soft-tissue images, and/or hard-tissue images, and/or displaying of the optimal, soft-tissue images, and/or hard-tissue images through a display, such as the display 160 of FIG. 1.

In one or more embodiments, at least any apparatus, system, and unit descriptions herein are hardware and include one or more hardware processing elements. For example, each described unit may include one or more processing elements, desirable memory, and any desired hardware input/output transmission devices. Further, the term apparatus should be considered synonymous with elements of a physical system, not limited to a single enclosure or all described elements embodied in single respective enclosures in all embodiments, but rather, depending on embodiment, is open to being embodied together or separately in differing enclosures and/or locations through differing hardware elements.

In addition to the above described embodiments, embodiments can also be implemented through computer readable code/instructions in/on a non-transitory medium, e.g., a computer readable medium, to control at least one processing device, such as a processor or computer, to implement any above described embodiment. The medium can correspond to any defined, measurable, and tangible structure configured to the store and/or transmit the computer readable code.

The media may also include, e.g., in combination with the computer readable code, data files, data structures, and the like. One or more embodiments of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Computer readable code may include both machine code, such as produced by a compiler, and files containing higher level code that may be executed by the computer using an interpreter, for example. The media may also be a distributed network, so that the computer readable code is stored and executed in a distributed fashion. Still further, as only an example, the processing element could include a processor or a computer processor, and processing elements may be distributed and/or included in a single device.

The computer-readable media may also be embodied in at least one application specific integrated circuit (ASIC) or Field Programmable Gate Array (FPGA), which executes (processes like a processor) program instructions.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques or methods are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A multi-energy X-ray system, the system comprising:
an image matching unit to match a plurality of target images representing plural energy bands of at least one X-ray, detected after passing through a target, by separating the plurality of target images into images for respective energy bands to generate at least one matched target image; and
a tissue discriminating unit to detect a specific region within the matched target image, to determine a difference image coefficient to separate images including the specific region into a plurality of tissue images, and to discriminate the plurality of tissue images from the matched target image using the difference image coefficient to generate at least one tissue image of the matched target image.

2. The system of claim 1, further comprising at least one X-ray source unit to radiate the at least one X-ray with at least two energy bands within a same predetermined period of time, under control of a controller, wherein the image matching unit and the tissue discriminating unit are comprised in an image processing/analyzing unit distinct from the X-ray source unit.

3. The system of claim 2, further comprising an X-ray detector to detect the at least two energy bands of the at least one X-ray within the predetermined period of time, under control of a controller, the X-ray detector being distinct from the X-ray source unit and the image processing/analyzing unit.

4. The system of claim 1, further comprising an X-ray source unit comprising:
a first X-ray source to radiate an X-ray with a first energy band and a second X-ray source to radiate an X-ray with a second energy band under control by a controller,
wherein the X-ray source unit is configured to radiate the X-ray with a first energy band and the X-ray with a second energy band toward the target within a same predetermined period of time under control by the controller.

5. The system of claim 1, wherein the image matching unit estimates an initial image of the target for a particular material based on the plural energy bands and known attenuation characteristics of the particular material.

6. The system of claim 1, wherein the specific region is a region determined by the tissue discriminating unit to be optimal for tissue discrimination, and distinguished by the tissue discriminating unit from candidate regions determined by the tissue discriminating unit to not be optimal for tissue discrimination.

7. The system of claim 1, wherein the tissue discriminating unit does not use information regarding spectrum characteristics of an X-ray source of the X-ray or a mass attenuation curve of the target to discriminate between hard and soft tissues

8. The system of claim 1, wherein the image matching unit separates the plurality of target images into images for each energy level, and applies a weighted sum scheme to the images to determine which target images to match.

9. The system of claim 1, wherein the specific region is detected by comparing a feature model image stored in a feature model storage unit with a result value obtained by performing a pattern analysis of the matched target image, the pattern analysis comprising an edge extraction algorithm and a frequency domain analysis with respect to the matched target image.

10. The system of claim 9, wherein the specific region is further detected based on user input data.

11. The system of claim 1, wherein the difference image coefficient is determined to be a value for minimizing a predetermined cost function.

12. The system of claim 11, wherein the cost function is defined by frequency characteristics of the plurality of tissue images.

13. The system of claim 11, wherein the cost function is defined by entropy characteristics of the plurality of tissue images.

14. The system of claim 1, further comprising:
a pre-processing unit to perform a pre-processing on the target images,
wherein the pre-processing separately stores surrounding target images of a Region of Interest (ROI).

15. The system of claim 1, further comprising:
a post-processing unit to perform a post-processing on the discriminated tissue images,
wherein the post-processing generates a de-blur mask based on an X-ray scattering modeling, and controls a contrast level of a soft tissue image, generated based on the difference image coefficient, using the de-blur mask.

16. The system of claim 1, wherein the tissue discriminating unit respectively determines plural difference image coefficients for different specific regions within a global region, generates at least one tissue image for each of the specific regions, and generates a global region image by respectively combining each tissue image of each specific region into a single image.

17. The system of claim 1, wherein the tissue discriminating unit respectively determines plural difference image coefficients for different specific regions within a global region, determines a global difference image coefficient for the global region, generates at least one tissue image for each of the specific regions respectively using the plural difference image coefficients, and generates a global image by respectively combining each tissue image of each specific region into a single image using a tissue image generated using the global difference image coefficient.

18. The system of claim 1, further comprising a display to display the at least one tissue image.

19. A method, the method comprising:
matching a plurality of target images representing plural energy bands of at least one X-ray, detected after passing through a target, by separating the plurality of target images into images for respective energy bands to generate at least one matched target image
detecting a specific region within the matched target image;
determining a difference image coefficient to separate images including the specific region into a plurality of tissue images; and
discriminating the plurality of tissue images from the matched target image using the difference image coefficient, the discriminating of the plurality of tissues images for generating at least one tissue image of the matched target image.

20. The method of claim 19, further comprising controlling at least one X-ray source unit to radiate the at least one X-ray with at least two energy bands within a same predetermined period of time.

21. The method of claim 20, further comprising controlling an X-ray detector to detect the at least two energy bands of the at least one X-ray within the predetermined period of time.

22. The method of claim 19, further comprising:
controlling a first X-ray source to radiate an X-ray with a first energy band and a second X-ray source to radiate an X-ray with a second energy band toward the target within a same predetermined period of time.

23. The method of claim 19, further comprising estimating an initial image of the target for a particular material based on the plural energy bands and known attenuation characteristics of the particular material.

24. The method of claim 19, wherein the specific region is a region determined in the detecting of the specific region to be optimal for tissue discrimination, distinguished from candidate regions determined in the detecting of the specific region to not be optimal for tissue discrimination.

25. The method of claim 19, wherein the method does not use information regarding spectrum characteristics of an X-ray source generating the X-ray or a mass attenuation curve of the target to discriminate between hard and soft tissues

26. The method of claim 19, wherein the specific region is detected by comparing a feature model image stored in a feature model storage unit with a result value obtained by performing a pattern analysis of the matched target image, the pattern analysis comprising an edge extraction and a frequency domain analysis with respect to the matched target image.

27. The method of claim 19, wherein the difference image coefficient is determined to be a value for minimizing a predetermined cost function.

28. The method of claim 19, further comprising:
performing a pre-processing on the target images,
wherein the pre-processing separately stores surrounding target images of a Region of Interest (ROI).

29. The method of claim 19, further comprising:
performing a post-processing on the discriminated tissue images,
wherein the post-processing generates a de-blur mask based on an X-ray scattering modeling, and controls a contrast level of a soft tissue image, generated based on the difference image coefficient, using the de-blur mask.

30. The method of claim 19, further comprising respectively determining plural difference image coefficients for different specific regions within a global region, generates at least one tissue image for each of the specific regions, and generating a global region image by respectively combining each tissue image of each specific region into a single image.

31. The method of claim 19, wherein respectively determining plural difference image coefficients for different specific regions within a global region, determining a global difference image coefficient for the global region, generating at least one tissue image for each of the specific regions respectively using the plural difference image coefficients, and generating a global image by respectively combining each tissue image of each specific region into a single image using a tissue image generated using the global difference image coefficient.

32. The method of claim 19, displaying the at least one tissue image on a display.

33. A non-transitory computer readable recording medium comprising computer readable code to control at least one processing device to implement the method of claim 19.
